(19) United States
(12) Patent Application Publication
(10) Pub. No.: US 2008/0247697 A1
(43) Pub. Date: Oct. 9, 2008

(54) End Cap for a Bearing Assembly

(75) Inventor: Werner Guilford, Hulmeville, PA (US)

Correspondence Address: MICHAUD-DUFFY GROUP LLP, 306 INDUSTRIAL PARK ROAD, SUITE 206, MIDDLETOWN, CT, 06457, US

(73) Assignee: ROLLER BEARING COMPANY OF AMERICA, INC., Oxford, CT (US)

(21) Appl. No.: 12/062,841

(22) Filed: Apr. 4, 2008

Related U.S. Application Data
(60) Provisional application No. 60/921,949, filed on Apr. 4, 2007.

(51) Int. Cl. F16C 33/76

(52) U.S. Cl. 384/489

(57) ABSTRACT

An end cap includes a body portion having an outer engagement portion for engaging an outer ring of a bearing, the bearing having an outer ring and an inner bearing structure disposed within the outer ring. The outer engagement portion is substantially annular about a central axis. The body member also has a central engagement portion for engaging the inner bearing structure. At least one of the outer engagement portion and central engagement portion is configured to mechanically couple the end cap to the bearing.

The bearing may have a seating portion on of the outer ring on the inner bearing member for mechanically coupling with the end cap. In a shaft and bearing assembly, there may be a seating portion on the inner bearing member or on the outer ring. The end cap body portion extends from the seating portion across the annular cavity to sealingly engage the shaft, the inner ring or the outer ring.

### CROSS-REFERENCE TO RELATED APPLICATION

This application claims the benefit of U.S. provisional application No. 60/921,949 filed Apr. 4, 2007, which is incorporated herein by reference.

### FIELD OF THE INVENTION

The present invention is generally directed to an end cap with a retaining portion for a bearing and is more specifically directed to a light weight end cap having a retaining portion capable of removably securing the end cap to a bearing assembly and resisting inadvertent removal from the bearing.

### BACKGROUND OF THE INVENTION

Many types of bearings can be used to support radial, thrust, or combination radial and thrust loads. Such bearings include ball, roller, plain, journal and tapered roller types. Some bearings include an outer ring and an inner ring disposed therein. Rolling elements such as balls, needles or rollers are rotatably positioned in a generally annular cavity between the outer and inner rings to facilitate rotational movement between the outer and inner rings. To reduce friction, a lubricant such as a grease or oil can be introduced or applied to and around the rolling elements.

Bearing performance can degrade, or severe and even catastrophic damage can occur, if insufficient lubricant is provided to the bearing. During operation, rolling element rotation can act to pump lubricant out of the bearing. In addition, bearing performance can be detrimentally affected as a result of contamination of the lubricant and/or the introduction of foreign matter into the annular cavity. One or more seals positioned in the annular cavity, between the inner and outer rings, have been used to help retain the lubricant within the annular cavity and to minimize contamination and foreign matter from entering therein. Such seals are typically made from a resiliently compliant material such as rubber, synthetic rubber or a composition thereof, such as Viton®. In some bearings, a seal is used on one end of the bearing and an end cap is utilized to extend over a portion of another end of the bearing adjacent the annular cavity thus providing sealing capability.

A fitting, such as a grease fitting, can be positioned on the end caps to provide a location for the introduction of lubricant to the bearing.

In connection with maintaining the bearing or the apparatus in which the bearing is employed, the bearing may be subjected to streams of high pressure, high velocity water, as from a power washer. Such streams of water can cause fasteners used to secure the end cap to loosen. In certain cases, the end cap can become disengaged. Without the end cap in place, the bearing can become contaminated by sand, dust or other fine particles, resulting in premature degradation in bearing performance or failure of the bearing.

### SUMMARY OF THE INVENTION

According to a first aspect of the present invention, an end cap for a bearing assembly includes a body member having an outer engagement portion for engaging an outer ring of a bearing having an outer ring and an inner bearing structure disposed within the outer ring. The outer engagement portion is substantially annular about a central axis. The body member also has a central engagement portion for engaging the inner bearing structure. At least one of the outer engagement portion and central engagement portion is configured to mechanically couple the end cap to the bearing.

According to another aspect of the present invention, a bearing includes an outer ring having a substantially cylindrical internal bearing surface and an inner ring having a substantially cylindrical external bearing surface and an inner wall defining a bore through the inner ring. The inner ring is coaxially disposed within the outer ring and cooperates with the outer ring to define an annular cavity therebetween. There are a plurality of rolling elements disposed within the annular cavity, the rolling elements being in rolling engagement with the external bearing surface and the internal bearing surface. The bearing includes an end cap that has a body portion which includes an outer engagement portion that engages the outer ring. The body portion also has a central engagement portion that engages the inner ring, and the body portion extends from the outer ring across the annular cavity to the inner ring. One of the outer engagement portion and the inner engagement portion is configured to mechanically couple the end cap to the bearing.

In yet another aspect, a shaft and bearing assembly includes a bearing having an outer ring, an inner bearing structure and a plurality of rolling elements. The outer ring has a substantially cylindrical internal bearing surface. The inner bearing structure has a substantially cylindrical external bearing surface and is coaxially disposed within the outer ring and cooperates with the outer ring to define an annular cavity therebetween. The plurality of rolling elements are disposed in the annual cavity and are in rolling engagement with the external bearing surface and the internal bearing surface. The shaft and bearing assembly includes a shaft disposed in the bearing. An end cap is mounted on the bearing. The end cap has a body portion including an outer engagement portion for engaging the outer ring and a central engagement portion for engaging the inner bearing structure. The body portion extends from the outer engagement portion across the annual cavity to the central engagement portion. One of the outer engagement portion and the central engagement portion is configured to mechanically couple to the bearing or to the shaft in the bearing.

### DESCRIPTION OF THE DRAWINGS

FIG. 1 is a cross sectional side view of a shaft and bearing assembly including an end cap in accordance with an embodiment of the present invention.

FIG. 2 is a cross sectional view of the end cap and a cut away portion of the shaft of the assembly of FIG. 1, wherein the end cap is inserted into the shaft.

FIG. 3 is an end view of the end cap of FIG. 2.

FIG. 4 is a cross sectional view similar to FIG. 2, but with end cap only partially inserted into the shaft, so that the detent member is in a compressed state.

FIG. 4A is a detail view of a part of FIG. 2.

FIG. 5 is a cross sectional view of the end cap with a shank having a through-bore, inserted into a shaft.

FIG. 6 is a cross sectional view of an end cap including a castellated shank having a through-bore.

FIG. 7 is an end view of the end cap of FIG. 6.

FIG. 8 is a cross sectional view of the end cap including a castellated shank having a through-bore and outwardly projecting protrusions extending therefrom.

FIG. 9 is a partial cross sectional view of an end cap installed on a bearing assembly in accordance with another embodiment of the invention.

FIG. 10 is a cross sectional view of the end cap of FIG. 9.

FIG. 11 is a bottom view of the end cap of FIG. 10.

FIG. 12 is a detail view of a portion of FIG. 9.

FIG. 13 is a detail view of the seating portion in the outer ring shown in FIG. 9.

FIG. 13A is a partial cross sectional view of an end cap installed on a bearing assembly in accordance with another embodiment of the invention.

FIG. 14 is a cross sectional view of an end cap including a castellated retaining portion according to another embodiment of the invention.

FIG. 15 is a bottom view of the end cap of FIG. 14.

FIG. 16A is a schematic cross-sectional view of a shaft and bearing assembly with an end cap according to yet another embodiment of this invention.

FIG. 16B is a detail view of a portion of FIG. 16A.

FIG. 17 is a schematic cross-sectional view of a shaft and bearing assembly with an end cap according to yet another embodiment of this invention

### DETAILED DESCRIPTION

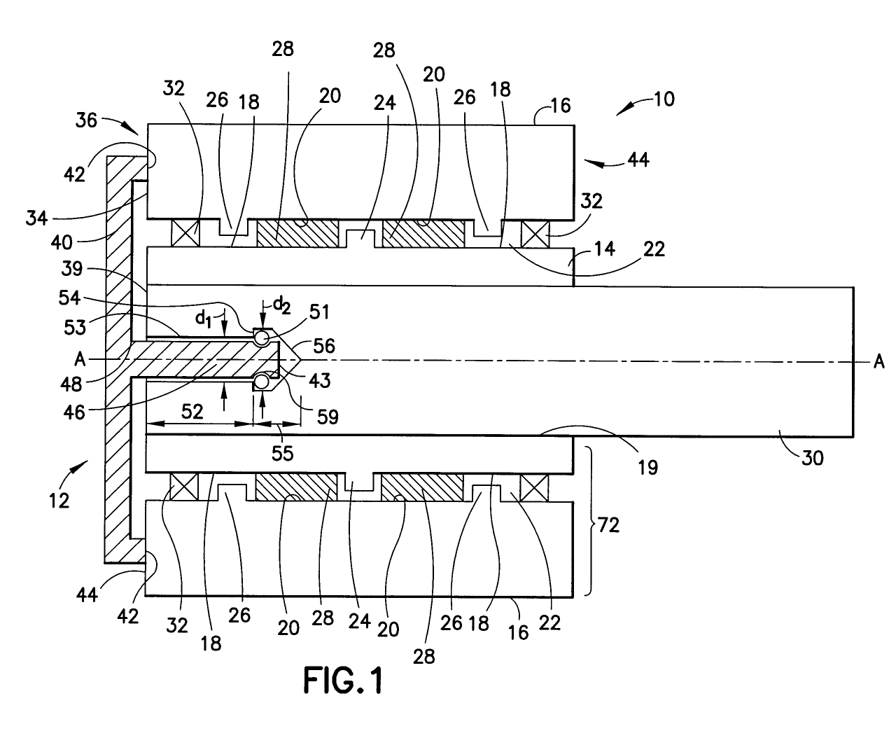

As shown in FIG. 1, a shaft and bearing assembly generally designated by the reference numeral 10 has an end cap 12 mounted thereon. The shaft and bearing assembly 10, may be a cam follower or a yoke roller or the like, includes a substantially cylindrical shaft 30 and a bearing 72 mounted thereon. The bearing 72 includes an outer ring 16, an inner bearing structure provided by an inner ring 14, and a plurality of rolling elements 28 positioned therebetween. The inner ring 14 has a substantially cylindrical external bearing surface 18 including at least one outwardly projecting shoulder 24. The inner ring 14 includes a substantially cylindrical inner wall 19 defining a bore which extends through the inner ring. The outer ring 16 of the bearing 72 has a substantially cylindrical internal bearing surface 20 including at least one inwardly projecting shoulder 26. The inner ring 14 is coaxially disposed within the outer ring 16, and the inner and outer rings cooperate to define an annular cavity 22 therebetween. A plurality of rolling elements 28, which may be needles, balls, rollers, or the like, are disposed in the annular cavity 22 in rolling engagement with the external bearing surface 18 and the internal bearing surface 20 so that the inner ring 14 and the outer ring 16 are rotatable relative to each other about their common axis A. The plurality of rolling elements 28 are positioned between the outwardly projecting shoulders 24 and the inwardly projecting shoulders 26. The bearing 72 also includes two seals 32 disposed between the external bearing surface 18 and the internal bearing surface 20 for retaining a lubricant within the annular cavity 22, with one seal positioned at the outboard end 36 of the bearing and one seal at the in-board end 44 of bearing. While two seals 32 have been shown and described, the present invention is not limited in this regard as less than or more than two seals can be employed without departing from the broader aspects of the present invention.

The portion of the shaft 30 disposed in the bore of the inner ring 14 is substantially cylindrical in configuration. The inner ring 14 may be pressed, shrunk, or otherwise secured onto the shaft 30. The inner ring 14 and the portion of the shaft 30 therein constitute an inner bearing structure of the shaft and bearing assembly 10.

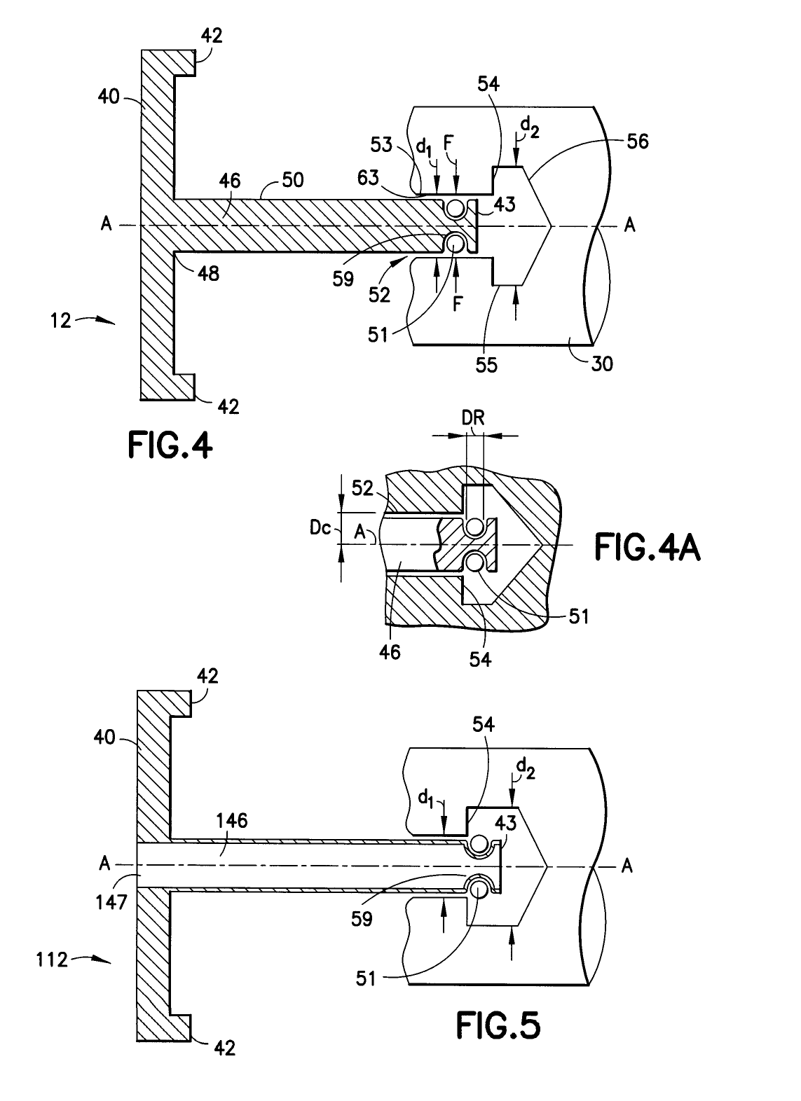

The shaft 30 has a bore 52 that is formed, cut or otherwise disposed in the distal end 39 of the shaft. The bore 52 has a first portion 53 that is adjacent the distal end 39 of the shaft 30 and that has a diameter d1. A second portion 55 of the bore 52 is adjacent the terminal end 56 of the bore and has a diameter d2. Diameter d2 is larger than d1, such that a shoulder 54 is formed in the bore 52 between the first portion 53 and the second portion 55, as seen in FIG. 4.

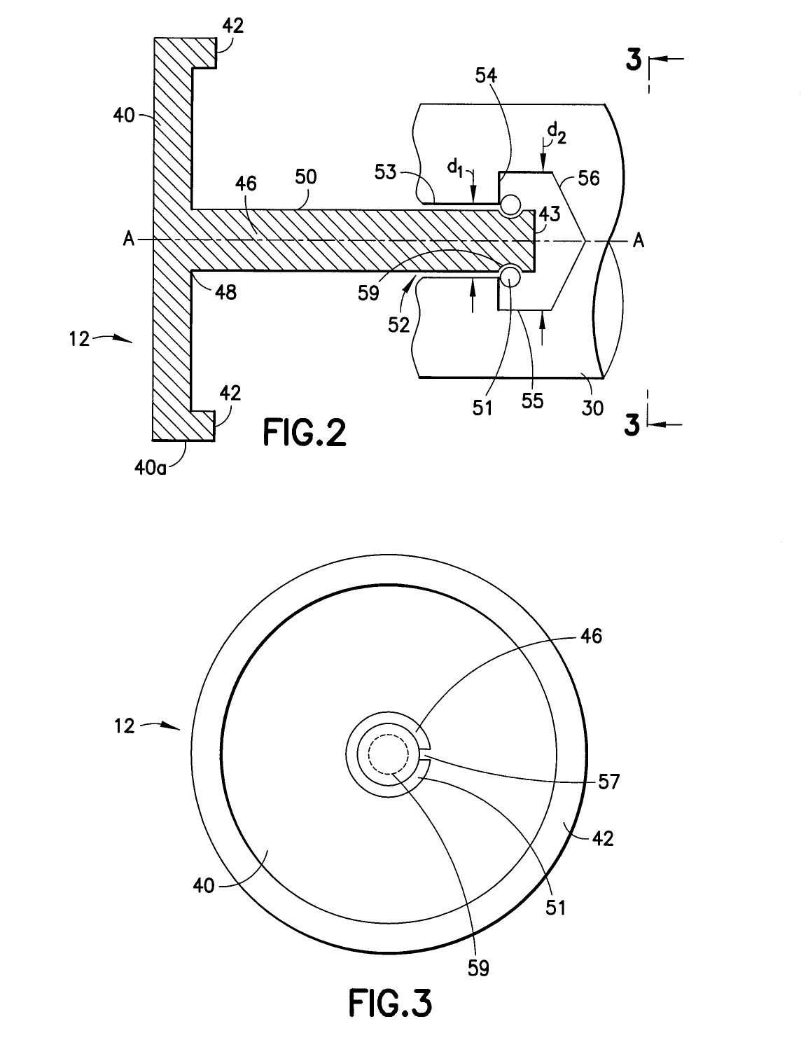

Referring to FIGS. 1-4, the end cap 12 has a body portion 40 that has an outer engagement portion and a central engagement portion. The outer engagement portion engages the outer ring of the bearing 72, and the central engagement portion engages the shaft 30 or inner ring 14. The engagement may be mutual surface contact that may inhibit the passage of particles, liquid and vapors therethrough (“sealing engagement”), or the engagement may be a mechanical coupling sufficient to retain the end cap 12 on the bearing or on the shaft. Sealing engagement may include sliding contact between the mutually engaging structures. In the end cap 12, the central engagement portion includes a substantially cylindrical shank 46 projecting outwardly from the body portion. The shank 46 has a first end 43 which defines a circumferential seating groove 59 for receiving a resilient split ring 51 having a gap 57 (FIG. 3) defined thereby.

The split ring 51 is configured to have, in a relaxed state, an outside diameter that exceeds d1 in the bore 52 and an inside diameter that does not exceed the diameter of the shank 46 (so that even in the relaxed state, the split ring 51 remains seated in the seating groove 59). In addition, the split ring 51 and the seating groove 59 are configured so that the split ring can be compressed to conform to a diameter d1. When the shank 46 is inserted into the shaft 30, the inner wall 63 of the first portion 53 of the bore 52 applies a force F (indicated in FIG. 4) on the split ring 51 that causes the split ring to compress, thus allowing the split ring 51 to advance through the first section 53 to the second section 55. In the second section 55, the split ring 51 expands and inhibits the withdrawal of the shank 46 from the bore 52 by bearing against the shoulder 54. Thus, the split ring 51 and the second section 55 and shoulder 54 function as a seat on the shaft for engaging the detent provided by the split ring 51. In this way, the shank 46 mechanically couples the end cap 12 to the shaft 30 without the need for supplemental mounting means such as screws, bolts, adhesive, etc.

Preferably, the shank 46 releasably engages the seating portion so that the end cap 12 can be removed from the shaft and bearing assembly 10 and may then be replaced, e.g., to temporarily expose the end of the shaft 30 and the outboard end 36 of the bearing 72 for inspection, maintenance or any other purpose. For example, the split ring 51 contacts the shoulder 54 at a point near its circumferential perimeter, i.e., at a radial distance Dc from the axis A to a point on the split ring beyond the greatest diameter DR of the split ring measured parallel to the axis A, as seen in FIG. 4A. An adequate withdrawal force can then cause the split ring 51 to again compress and allow the shank 46 to be withdrawn from the shaft 30, thus allowing the end cap to be removed from the shaft and bearing assembly 10. Alternatively, or in addition to contacting the split spring 51 as just described, the shoulder 54 may be slanted so that the shoulder acts as the surface of a cam that compresses the split spring as the end cap 12 is withdrawn from the bore 52.

The body portion 40 of the end cap 12 has a disc-like configuration which extends from the central engaging portion (i.e., from the shank 46) radially outward, across the annual cavity to an outer engagement portion 42 disposed thereon which sealingly engages the mating surface 34 of the outer ring 16. Thus, the end cap 12 provides a barrier to the introduction of contamination and foreign matter into the annular cavity 22.

Although the detent on the end cap 12 is shown as a split ring 51 fitted into a seating groove 59, the present invention is not limited in this regard, as other suitable detent members can be used to mechanically couple the end cap 12 to the shaft and bearing assembly 10, including but not limited to ball and spring mechanisms, protrusions or resilient fingers projecting outwardly from the outer surface 50, or a combination thereof. Furthermore, the seat on the shaft and bearing assembly 10 that engages the detent member may be a detent-receiving groove of any form suitable to the detent member. Moreover, although the end cap 12 includes a detent member, the present invention is not limited in this regard, as it will be apparent to one of ordinary skill in the art that the engagement portion on the end cap 12 that mechanically couples the end cap to the shaft and bearing assembly 10 may comprise a seating portion for a detent on the shaft and bearing assembly.

While the shank 46 has been described above as being substantially cylindrical, the present invention is not limited in this regard as the shank can be of any suitable cross-sectional shape including but not limited to hexagonal, square and star-shaped cross sections. The end cap 12 can be manufactured from a resilient plastic material such as polyurethane and the split ring 51 can be manufactured from spring steel, however, the invention is not limited in this regard as other materials may be used for the end cap 12, including but not limited to metals, composite materials and combinations thereof, and/or other materials may be used for the split spring 51 or other detents, including but not limited to other metals, composite materials and combinations thereof.

While the bearing 72 is shown with two sets of rolling elements 28 separated by a shoulder 24 that projects from the inner ring 14, this is not a limitation on the invention, and various other configurations of bearings, rolling elements, etc. are known in the art and, in view of the disclosure herein, all such bearings and shaft and bearing assemblies can employ an end cap as described herein.

The end cap 112 shown in FIG. 5 is similar in configuration to the end cap 12 shown in FIGS. 1-4, and the foregoing description of end cap 12 will apply to end cap 112 correspondingly, with the following differences. The end cap 112 has a hollow shank 146 which defines a passage 147 that extends from the first end 43 of the shank to the second end 48 and through the body portion 40. The shank 146 sealingly engages the inner wall 63. The passage 147 allows the escape of air from the bore 52 to avoid compressing air therein while the end cap 112 is mounted on the shaft and bearing assembly 10.

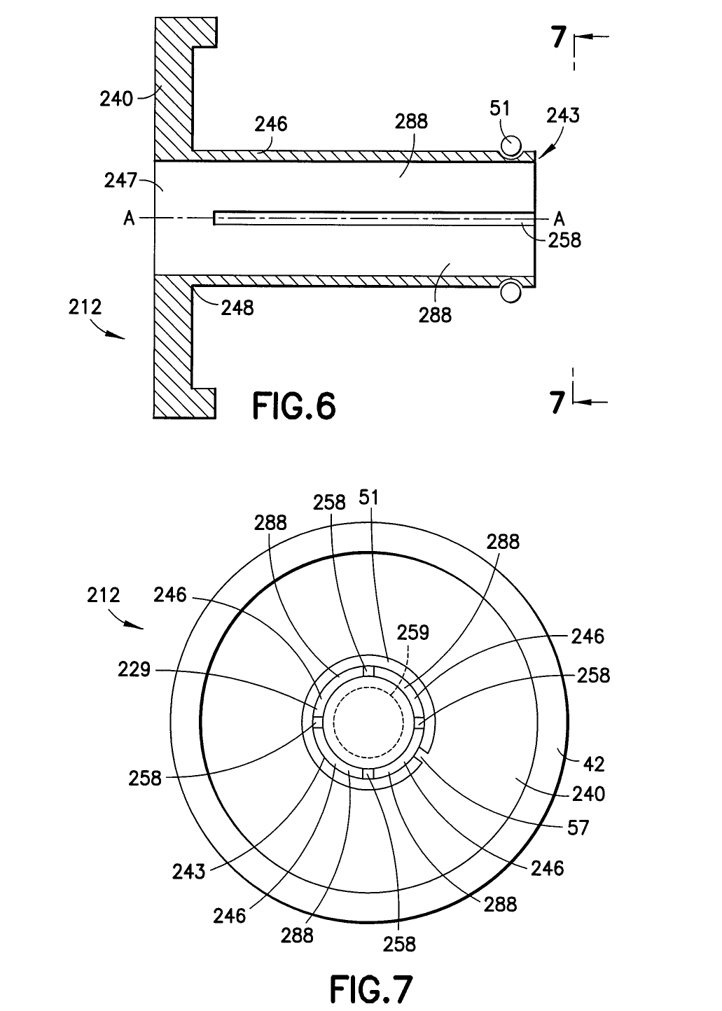

The end cap 212 shown in FIGS. 6 and 7 is similar in configuration to the end cap 112 shown in FIG. 5, and the foregoing description of end cap 112 will apply to end cap 212 correspondingly, with the following differences. The end cap 212 includes a shank 246 which is a substantially hollow cylindrical shell open on opposing ends and defining a passage 247 extending therethrough. The shank 246 includes a castellated portion defined by a plurality of slits 258 formed at the first end 243 and terminating between the first end and the second end 248. The slits 258 define a plurality of shank segments 288. The slits 258 allow the shank segments 288 to flex when sliding the shank 246 into the shaft 30 to engage the seating portion in the shaft.

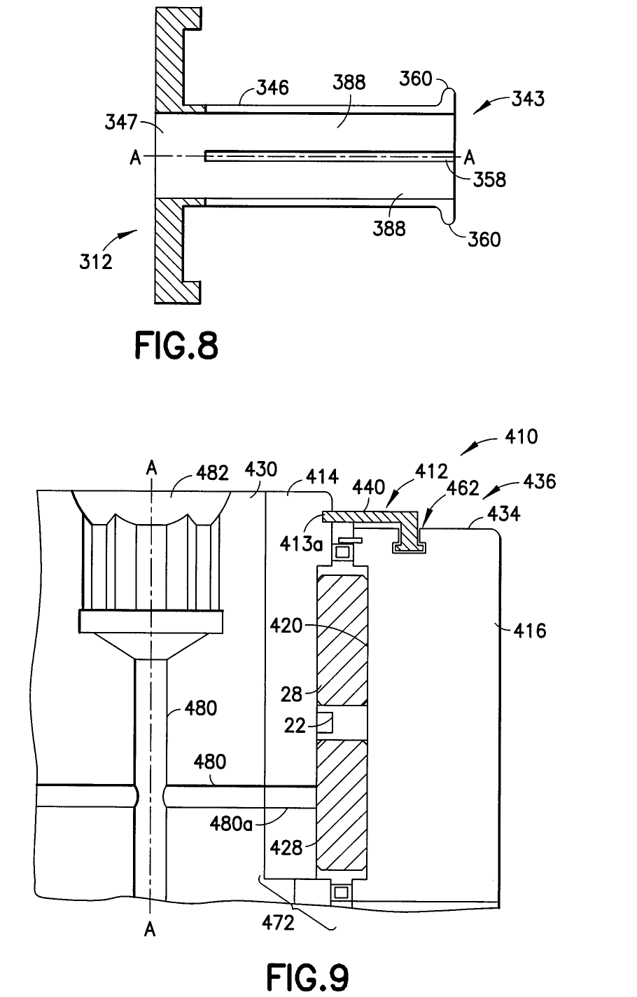

The end cap 312 shown in FIG. 8 is similar in configuration to the end cap 212 shown in FIGS. 6 and 7, the foregoing description of end cap 12 will apply to end cap 312 correspondingly, with the following differences. The end cap 312 includes a shank 346 which is a substantially hollow cylindrical shell open on opposing ends and defining the passage 347 extending therethrough. The shank 346 further includes a castellated portion defined by a plurality of slits 358 formed in the first end 343 and defining a plurality of flexible shank segments 388. There is no split ring or seating groove to correspond to split ring 251 and seating groove 259, but the shank 346 includes detent members having protrusions 360 projecting outwardly from the shank segments 388, at the first end 343 of the shank. The protrusions 360 can engage the seating portion of the shaft and bearing assembly 10 in a manner similar to that described above for the split ring 51 of end cap 12.

The shaft and bearing assembly 410 shown in FIGS. 9-13 are similar in configuration to the shaft and bearing assembly 10 shown in FIGS. 1-4, the foregoing description of the shaft and bearing assembly 10 will apply to the shaft and bearing assembly 410 correspondingly, with the following differences. The outer ring 416 of the bearing assembly 410 defines a detent-receiving groove 462 disposed on an end 436 of the outer ring, to provide a seating portion. The detent-receiving groove 462 is disposed on an end surface 434 on an end 436 of the outer ring 416 which is substantially perpendicular to the axis A.

The detent-receiving groove 462 is formed, cut or otherwise disposed in the end 436 and defines a shoulder 464. The shoulder 464 is defined by a transition between a first section 466 of the detent-receiving groove 462 having an inside diameter d3 and a second section 468 of the detent-receiving groove 462 having an increased diameter d4 adjacent the terminal end 470 of the bore, wherein d4 is greater than d3.

The inner ring 414 extends axially towards the end of the shaft 430 than does the outer ring 416, so that part of the substantially cylindrical external bearing surface 418 extends beyond the annular cavity 422.

The end cap 412 on the shaft and bearing assembly 410 has a body portion 440 but no shaft portion. The end cap 412 is manufactured from a resilient plastic material such as polyurethane. The body portion 440 has an annular configuration having an inner portion 413a which provides the central engagement portion of the end cap 412. The annular inner portion 413a mechanically engages a groove (unnumbered) on the inner ring 414, the groove providing a seat for retaining the end cap 412 on the shaft and bearing assembly 410.

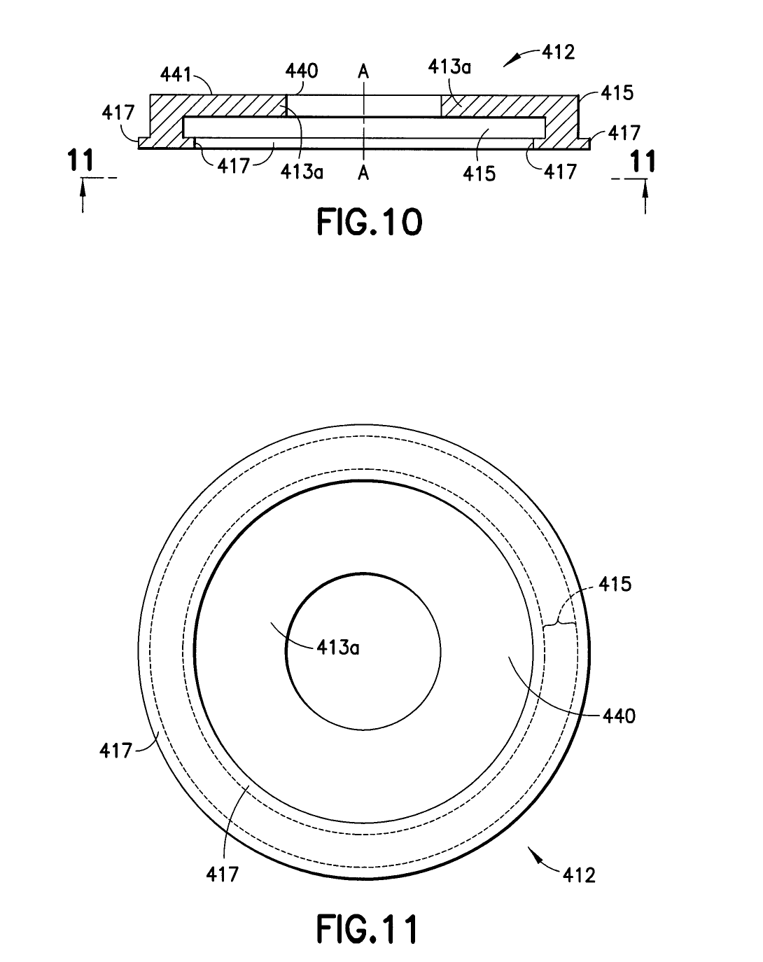

The end cap 412 includes a lip 415 (FIG. 10) to provide a retaining portion projecting from the body portion 440. The lip 415 is a resilient cylindrical shell disposed about a periphery of the body portion 440. The lip 415 includes a protrusion 417 to provide a detent member for sealingly and releasably securing the end cap 412 to a seating portion the bearing assembly 410.

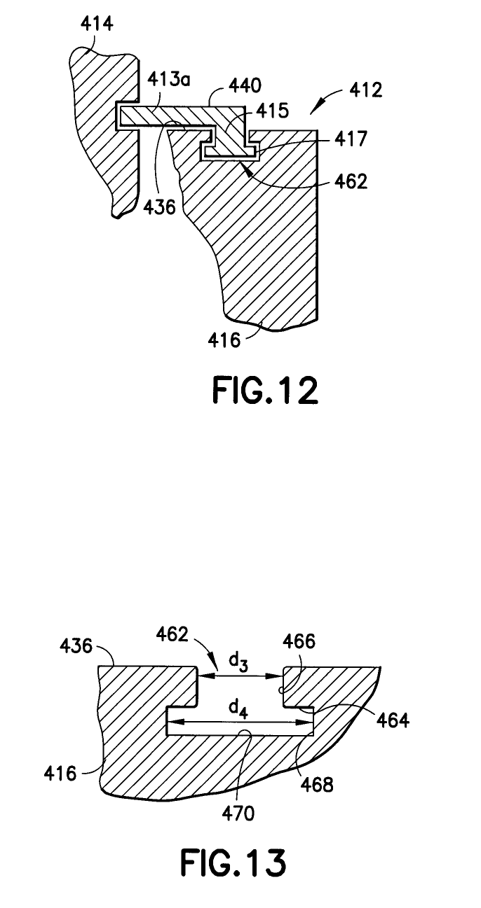

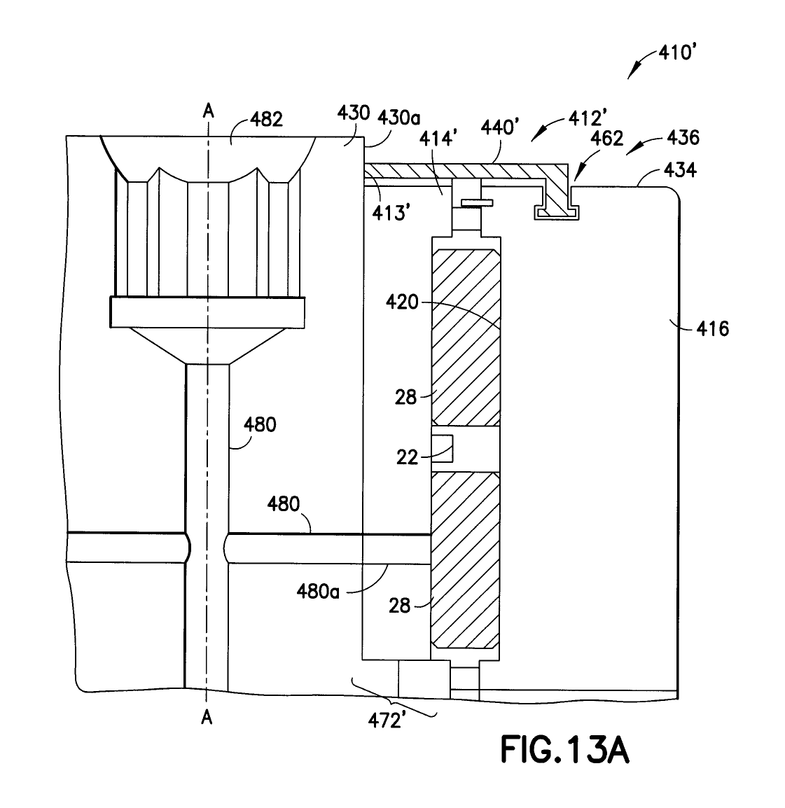

Referring to FIGS. 12 and 13, when the lip 415 is inserted into the detent-receiving groove 462 within the first section 466, a radially and inwardly directed reaction force applied by the detent-receiving groove 462 onto the protrusion 417 causes the lip 415 to deform and allows the lip 415 to travel into the bore. When the protrusion 417 moves into the second section 468, the protrusion 417 relaxes and abuts the shoulder 464 thus inhibiting removal of the lip 415 from the detent-receiving groove 462.

The shaft 430 includes flow paths 480 and a port 482 for conveying a lubricant to the annular cavity 422 via an inner ring flow path aperture 480a. In operation, the lubricant can by supplied to the bearing assembly 410 without removing the end cap 412.

While the end cap 412 is shown engaging inner ring 414, the present invention is not limited in this regard as an inside circumferential surface may alternatively engage a portion of a shaft in the bearing. For example, in the shaft and bearing assembly 410′ shown in FIG. 13A, which has generally the same configuration as the shaft and bearing assembly 410 shown in FIG. 9, the inner ring 414′ does not extend as far in the axial direction along the shaft 430 as the inner ring 414 of FIG. 9, and so the cylindrical mating portion 430a on the shaft is exposed. The end cap 412′ has a larger body portion 440′ than the body portion 440 of the end cap 412, and the larger body portion 440′ reaches over the inner ring 414′ from the outer ring 416 to engage the mating portion 430a.

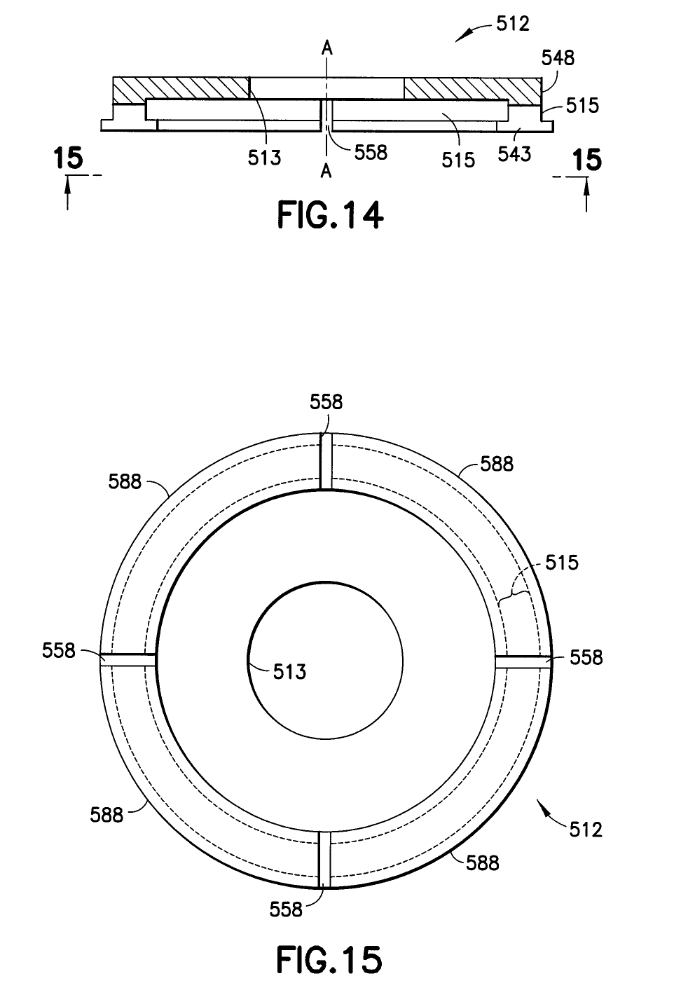

The end cap 512 shown in FIGS. 14 and 15 is similar in configuration to the end cap 412 shown in FIGS. 9-12, and the foregoing description of end cap 412 will apply to end cap 512 correspondingly, with the following differences. The lip 515 has a castellated configuration defined by a plurality of axially extending slits 558 formed, cut or otherwise disposed in the cylindrical shell and defining a plurality of segments 588 (FIG. 15). The slits 558 extend between the first end 543 and the second end 548 and allow the segments 588 to flex when sliding the lip 515 into the seating portion. The end cap 512 can be used on a shaft and bearing assembly in the same manner as end cap 414, e.g., in one embodiment the inside circumferential surface 513 may sealingly engage an inner ring 414 or a shaft 430.

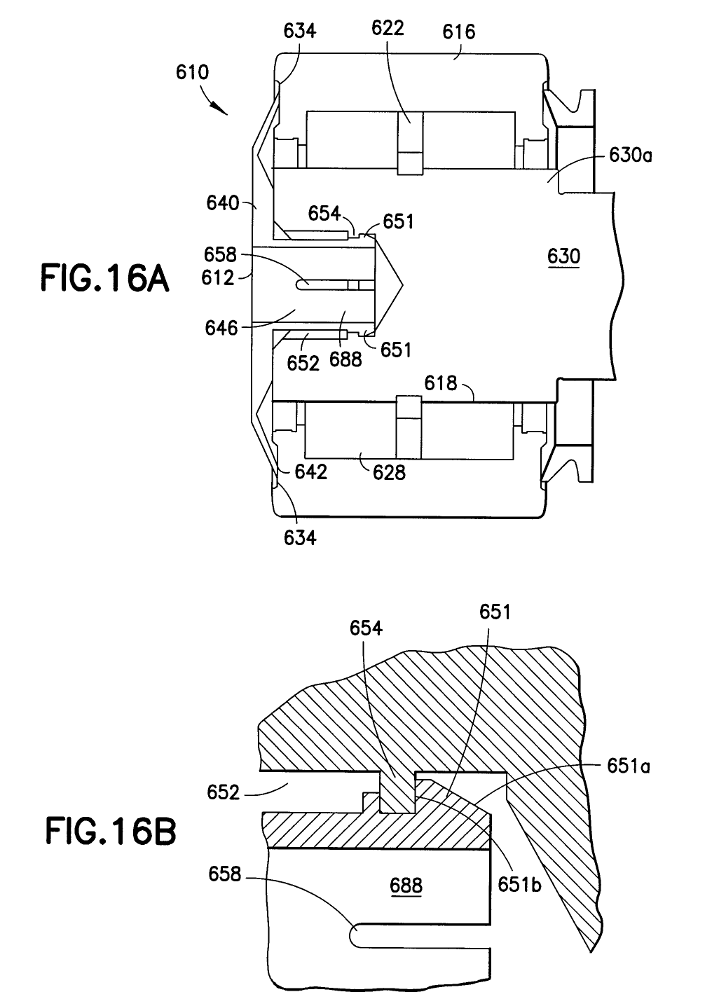

In another embodiment, the inner bearing structure is integral with the shaft, as seen in the shaft and bearing assembly 610 of FIG. 16. Accordingly, the outer ring 616 is coaxially disposed about the end of the shaft 630 to define an annular cavity 622 between the outer ring and a cylindrical stepped end portion 630a of the shaft. The cylindrical stepped end portion 630a of the shaft provides a substantially cylindrical external bearing surface 618, and the rolling elements 628 are disposed in the annular cavity in rolling contact with the outer ring 616 and the shaft 630. An end cap 612 is mounted on the shaft and bearing assembly 610. The end cap 612 has a body portion 640 that includes a shank 646 extending therefrom for insertion into a bore 652 in the end of the shaft 630. The bore 652 may have a hexagonal configuration. The shank 646 has a bore therethrough and has, at the insertion end, a castellated configuration provided by slits 658 that divide the shaft into flexible segments 688. The shank 646 includes barbs 651 on the flexible segments 688, and the bore 652 in the shaft 630 includes an internal rib or undercut 654 in the bore 652. As seen in FIG. 16B, each barb 651 has an outward-facing wedge surface 651a and a stop shoulder 651b. The barb 651 is configured so that as the end cap 612 is inserted into the bore 652, the wedge surface 651a engages the rib 654 and, as the shank 646 advances in the bore, the barb causes the segment on which it is disposed to flex inward. Then, once the shoulder 651b passes the rib 654, the segment flexes outward and the shoulder 651b engages the rib 654 to inhibit removal of the end cap 612 from the shaft 630. In this way, the shoulder 654 provides a seat for receiving the barb 651, whereby to retain the end cap 612 on the shaft and bearing assembly 610. The body portion 640 of the end cap 612 is configured so that when the barb 651 engages the rib 654, the body portion extends across the annular cavity 622 to where an annular sealing surface 642 on the body portion engages an annular recessed mating surface 634 on the outer ring 616.

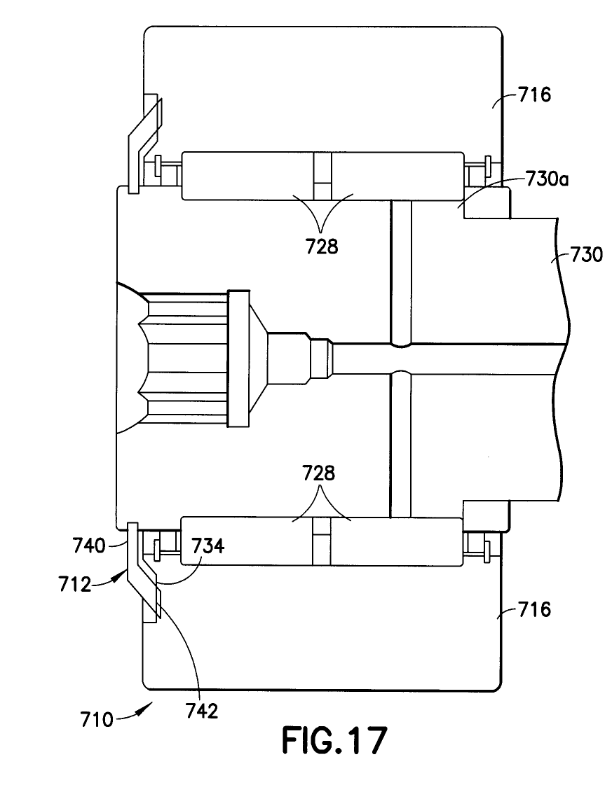

As seen in the shaft and bearing assembly 710 shown in FIG. 17, an end cap 712 may have a body portion 740 that does not include a shank. Rather, the end cap 712 has a central engaging portion that is seated in a circumferential groove in the shaft 730. The body portion 740 extends from the central engaging portion to a sealing surface 742 that sealingly engages a recessed mating surface 734 on the end of the outer ring 716. The shaft and bearing assembly 710 includes rolling elements 728 that contact the outer ring 716 and a cylindrical stepped end portion 730a of the shaft 730 that provides a substantially cylindrical external bearing surface.

Although the present invention has been disclosed and described with reference to certain embodiments thereof, it should be noted that other variations and modifications may be made, and it is intended that the following claims cover the variations and modifications within the true spirit of the invention.

What is claimed is:

1. An end cap for a bearing assembly, comprising:
a body member having a outer engagement portion for engaging an outer ring of a bearing having an outer ring and an inner bearing structure disposed within the outer ring, the outer engagement portion being substantially annular about a central axis; and
the body member also having a central engagement portion for engaging an inner bearing structure;
wherein at least one of the outer engagement portion and central engagement portion is configured to mechanically couple to the bearing.

2. The end cap of claim 1, wherein the central engagement portion comprises a detent member.

3. The end cap of claim 2, wherein the outer engagement portion comprises a substantially annular sealing surface in a plane perpendicular to the central axis.

4. The end cap of claim 3, wherein the central engagement portion comprises a shank projecting outwardly from the body portion.

5. The end cap of claim 4, wherein and shank comprises a detent member.

6. The end cap of claim 5, wherein the detent member is a barb, a split ring or a protrusion.

7. The end cap of claim 1, wherein the shank has an axial passage extending at least partially therethrough.

8. The end cap of claim 7, wherein the shank has a castellated configuration defining a plurality of flexible segments.

9. The end cap of claim 8, wherein at least one flexible segment has a detent member thereon.

10. The end cap of claim 1, the end cap comprising a resilient plastic material.

11. A bearing comprising:
an outer ring having a substantially cylindrical internal bearing surface;
an inner ring having a substantially cylindrical external bearing surface and an inner wall defining a bore through the inner ring, the inner ring being coaxially disposed within the outer ring and defining an annular cavity therebetween;
a plurality of rolling elements disposed within the annular cavity, the rolling elements being in rolling engagement with the external bearing surface and the internal bearing surface; and
an end cap having a body portion including an outer engagement portion that engages the outer ring and a central engagement portion that engages the inner ring, the body portion extending from the outer ring across the annular cavity to the inner ring;
wherein one of the outer engagement portion and the inner engagement portion is configured to mechanically couple the end cap to the bearing.

12. The bearing of claim 11 wherein the inner ring has a groove that provides a seat for mechanically receiving and retaining the central engagement portion of the end cap.

13. The bearing of claim 12 wherein the outer engagement portion comprises a sealing surface that sealingly engages a mating surface on the outer ring.

14. The bearing of claim 11, wherein the outer engagement portion defines a lip projecting from the body portion, and wherein the outer ring comprises a seating portion for mechanically receiving and retaining the lip.

15. The bearing of claim 14, wherein the inner engagement portion comprises a sealing surface that sealingly engages a mating surface on the inner ring.

16. The bearing of claim 14, wherein the lip comprises a detent member.

17. The bearing of claim 14, wherein the lip defines:
a substantially cylindrical shell having a first end and a second end;
the cylindrical shell having a plurality of slits circumferentially disposed around the cylindrical shell to define a plurality of flexible shell segments.

18. The bearing of claim 17, wherein at least one of the segments defines at least one protrusion projecting therefrom.

19. The bearing of claim 14, wherein the central engagement portion includes an inside circumferential surface, and wherein the inside circumferential surface sealingly engages a portion of the external bearing surface.

20. The bearing of claim 11, the end cap comprising a resilient plastic, a resilient metal or a resilient composite material.

21. The bearing of claim 11 wherein the end cap is mechanically coupled to the bearing without supplemental coupling means.

22. A shaft and bearing assembly comprising:
a bearing comprising an outer ring, an inner bearing structure and a plurality of rolling elements;
the outer ring having a substantially cylindrical internal bearing surface;
the inner bearing structure having a substantially cylindrical external bearing surface and being coaxially disposed within the outer ring and cooperating with the outer ring to define an annular cavity therebetween;
the plurality of rolling elements disposed in the annual cavity, the rolling elements being in rolling engagement with the external bearing surface and the internal bearing surface;
a shaft disposed in the bearing; and
an end cap having a body portion including an outer engagement portion for engaging the outer ring and a central engagement portion for engaging the inner bearing structure, the body portion extending from the outer engagement portion across the annual cavity to the central engagement portion, and wherein one of the outer engagement portion and the central engagement portion is configured to mechanically couple to the bearing or to the shaft in the bearing.

23. The assembly of claim 22 wherein the end cap is releasably secured to the shaft and bearing assembly.

24. The assembly of claim 23, wherein the central retaining portion defines a detent member, and wherein the shaft defines a seat for the detent member to mechanically couple the end cap to the shaft and bearing assembly.

25. The assembly of claim 22, wherein the outer retaining portion defines a detent member, and wherein the outer ring defines a seat for the detent member to mechanically couple the end cap to the shaft and bearing assembly.

26. The assembly of claim 22, wherein the end cap is mechanically coupled to the assembly without supplemental coupling means.
